(19) United States
(12) Patent Application Publication
(10) Pub. No.: US 2011/0025751 A1
(43) Pub. Date: Feb. 3, 2011

(54) INKJET PRINTER WITH INK TEMPERATURE ADJUSTMENT MECHANISM

(75) Inventor: Hiroshi HASHI, Tokyo (JP)

Correspondence Address: Frishauf, Holtz Goodman & Chick, P.C.;16th Floor, 220 Fifth Avenue, New York, NY, 10001-7708, US

(73) Assignee: Olympus Corporation, Tokyo (JP)

(21) Appl. No.: 12/844,116

(22) Filed: Jul. 27, 2010

(30) Foreign Application Priority Data
Jul. 29, 2009 (JP) 2009-176670

(51) Int. Cl. B41J 29/38

(52) U.S. Cl. 347/17

(57) ABSTRACT

An inkjet printer includes a head section, an ink heating section, and an ink cooling section. The head section includes an ink head which discharges ink. The ink heating section heats the ink supplied to the head section. The ink cooling section cools the ink supplied to the head section. The ink flows through the ink cooling section, the ink heating section and the head section in the order mentioned.

### CROSS-REFERENCE TO RELATED APPLICATIONS

This application is based upon and claims the benefit of priority from prior the Japanese Patent Application No. 2009-176670, filed Jul. 29, 2009 the entire contents of which are incorporated herein by references.

### BACKGROUND OF THE INVENTION

1. Field of the Invention

The present invention relates to an inkjet printer comprising a heating section which heats ink, and a cooling section which cools ink.

2. Description of the Related Art

There are known inkjet printers in which ink is discharged from plural nozzles to record desired images on a recording media.

Viscosity of ink varies depending on temperatures. When a temperature of ink is low, viscosity of the ink increases. On the contrary, when a temperature of ink is high, viscosity of the ink decreases. Accordingly, a discharge amount of ink discharged from an ink head varies depending on temperatures of the ink.

In this respect, Jpn. Pat. Appln. KOKAI Publication No. 2001-270090 discloses comprising of a heating section which heats ink, and a cooling section which cools ink. The heating and cooling sections are controlled to drive based on a temperature of ink. The temperature of ink is thereby maintained within a predetermined temperature range.

### BRIEF SUMMARY OF THE INVENTION

According to an aspect of embodiments, there is provided an inkjet printer comprising: a head section including an ink head which discharges ink; an ink heating section including a heater which heats the ink supplied to the head section; and an ink cooling section including a heat sink which cools the ink supplied to the head section, wherein the ink which has passed through the ink cooling section and the ink heating section in this order flows into the head section.

Another an inkjet printer according to the present invention comprising: an inkjet printer comprising: an ink tank which stores ink; a head section including an ink head which discharges the ink supplied from the ink tank through a first path; a pump which returns the ink not discharged from the head section, back to the ink tank through a second path; an ink heating section including a channel section through which the ink flows, and a heater which heats the channel section; an ink cooling section including a channel section through which the ink flows, and a heat sink which radiates heat of the ink flowing through the channel section; a temperature sensor which detects a temperature of the ink; and a control section which drives the heater if the temperature of the ink is detected to be lower than a predetermined temperature range by the temperature sensor, wherein the ink heating section is provided on the first path, and the ink cooling section is provided on the first path between the ink tank and the ink cooling section or on the second path.

Further, another an inkjet printer according to the present invention comprising: an inkjet printer comprising: a first tank which stores ink; a head section including an ink head which discharges the ink supplied from the first tank through an ink supply path; a second tank which collects, through an ink collection path, the ink not discharged from the head section; a pump which returns the ink collected by the second tank, back to the first tank through an ink feed back path; an ink heating section including a heater which heats the ink; an ink cooling section which cools the ink by radiating heat of the ink through a heat sink; a temperature sensor which detects a temperature of the ink; and a control section which drives the heater if the temperature of the ink is detected to be lower than a predetermined temperature range by the temperature sensor, wherein the ink heating section is provided on the ink supply path, and the ink cooling section is provided on the ink supply path between the first tank and the ink heating section or is provided on the ink collection path or on the ink feedback path.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a conceptual configuration of an inkjet printer including an ink heating section and an ink cooling section, according to a first embodiment.

FIG. 2A is a view showing a first example of the ink cooling section.

FIG. 2B is a view showing a second example of the ink cooling section.

FIG. 3 is a view showing a conceptual configuration of an inkjet printer including an ink heating section and an ink cooling section, according to a first modification of the first embodiment.

FIG. 4 is a view showing a conceptual configuration of an inkjet printer including an ink heating section and an ink cooling section, according to a second modification of the first embodiment.

FIG. 5 is a view showing a conceptual configuration of an inkjet printer including an ink heating section and an ink cooling section, according to a third modification of the first embodiment.

FIG. 6 is a view showing a conceptual configuration of an inkjet printer including an ink heating section and an ink cooling section, according to a second embodiment.

FIG. 7 is a view showing a conceptual configuration of an inkjet printer including an ink heating section and an ink cooling section, according to a third embodiment.

FIG. 8 is a view showing a conceptual configuration of an inkjet printer including an ink heating section and an ink cooling section, according to a first modification of the third embodiment.

### DETAILED DESCRIPTION OF THE PREFERRED EMBODIMENT

Hereinafter, embodiments of the present invention will be described in detail below with reference to the drawings.

### First Embodiment

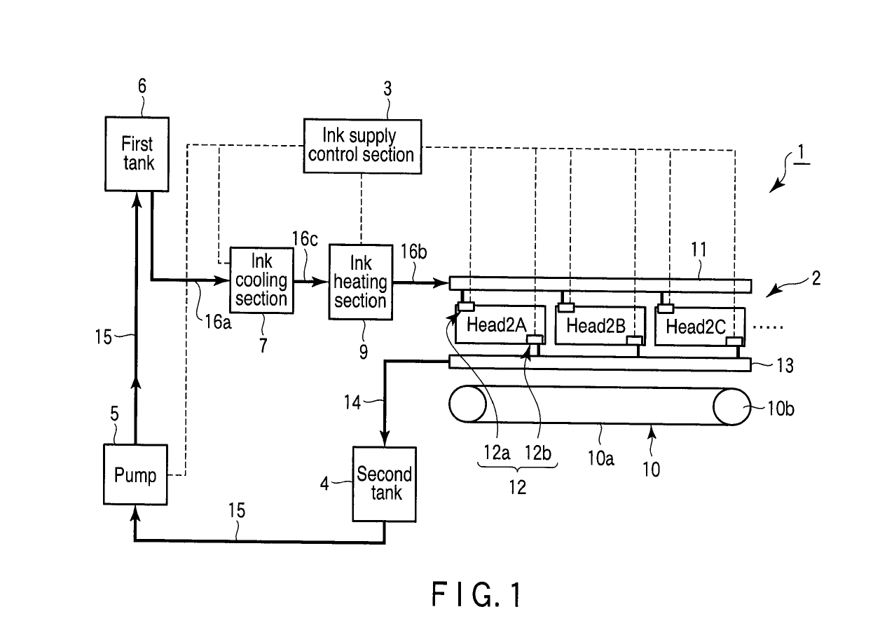

FIG. 1 illustrates a conceptual configuration of an image recording apparatus, namely an inkjet printer which comprises an ink heating section and an ink cooling section, according to a first embodiment. The present embodiment described below is based on a prerequisite that an inkjet printer records color images by using inks of plural colors. However, to simplify the description, an ink circulation path for ink of one color will be representatively described below as an example.

The inkjet printer 1 comprises at least: a first ink tank 6; a head section 2; an ink cooling section 7; an ink heating section 9; a second ink tank 4; a pump 5; an ink circulation path denoted by 14, 15, 16a, 16b, and 16c, which connect the foregoing members; an ink supply control section 3 which controls the pump 5, the ink cooling section 7 and the ink heating section 9; and a conveyor mechanism 10 which conveys a recording The first ink tank 6 is a supply tank (ink tank) containing ink to be supplied to the head section 2. This first ink tank 6 is provided with an unillustrated liquid surface sensor. In this manner, the ink in the first ink tank 6 is maintained at a predetermined amount.

The second ink tank 4 is a collection tank in which the ink not used by the head section 2 is collected. This second ink tank 4 is provided with an unillustrated liquid surface sensor. In this manner, the ink in the second ink tank 4 is maintained at a predetermined amount.

The first ink tank 6 or second ink tank 4 is connected to an attachable/detachable tank which is filled with ink. Based on the unillustrated liquid surface sensor, the first ink tank 6 or second ink tank 4 is appropriately charged with ink from the tank.

In the embodiment, the first ink tank 6 is located above the head section 2 in the direction of gravitation force, and is open to the air during ink circulation. The second ink tank 4 is located below the head section 2 in the direction of gravitational force, and is maintained at a constant negative pressure by an unillustrated pressure adjustment member. In this manner, the head section 2 is applied with a predetermined negative pressure, and menisci are formed during ink circulation.

An ink circulation path is constituted by: an ink supply path 16 as a first path which supplies ink from the first ink tank 6 to the head section 2; an ink collection path 14 through which ink not discharged from the head section 2 is collected to the second ink tank 4; and an ink feedback path 15 which feeds back ink in the second ink tank 4 to the first ink tank 6. The ink collection path 14 and the ink feedback path 15 constitute a second path which returns ink not discharged from the head section 2, back to the first tank 6.

On the ink supply path 16, the ink cooling section 7 and the ink heating section 9 are provided. The ink supply path 16a connects the first ink tank 6 and the ink cooling section 7. The ink supply path 16b connects the ink heating section 9 and the head section 2. The ink supply path 16c connects the ink cooling section 7 and the ink heating section 9.

Further, the pump 5 is provided on the ink feedback path 15. The pump 5 is controlled by the ink supply control section 3. The pump 5 pumps up and feeds back ink from the second ink tank 4 to the first ink tank 6. The ink circulation path basically uses a flexible pipe made of a resin material.

The head section 2 is a line inkjet head which discharges ink in the form of liquid drops. As illustrated in FIG. 1, the present embodiment is an example using plural short heads 2A, 2B, and 2C. The short heads 2A, 2B, and 2C are arrayed in a line such that an image can be recorded over a range of a recordable area on each recording medium, in a direction perpendicular to a conveying direction of the recording medium such as a paper sheet to convey.

The ink inlet ports (ink supply ports) of the short heads 2A, 2B and 2C are connected to an upstream ink bus 11. The upstream ink bus 11 is configured to supply a uniform amount of ink to the short heads 2A, 2B and 2C. The ink outlet ports (ink ejection ports) of the short heads 2A, 2B and 2C are connected to a downstream ink bus 13. The downstream ink bus 13 collects the ink not ejected from the short heads 2A, 2B and 2C.

FIG. 1 illustrates the three short heads 2A, 2B, and 2C. In actuality, however, six short heads are used, for example, and are arranged in a staggered layout such that ends of nozzle rows of the short heads partially overlap each other between the short heads. The inkjet head is thus configured. Of course, the number of short heads to constitute the line inkjet head is not limited to six but can be arbitrarily set.

In the present embodiment, the head section 2 is embodied as a line inkjet head, but is not limited to this. For example, it may be a serial inkjet head configured to execute recording while scanning over a recording medium. In other words, the head section 2 may be either a line type or a serial type as long as it can record images by jetting ink.

A large number of nozzles (piezoelectric elements) and a head drive circuit (circuit board) are provided for the short heads 2A, 2B, and 2C. The nozzles discharge ink and are arrayed in rows. The head drive circuit inputs a drive waveform to selected piezoelectric elements and causes the elements to discharge ink.

Further, each of ink supply ports of the short heads 2A, 2B, and 2C is provided with a temperature sensor 12a as a first temperature sensor for detecting a temperature of ink which has flowed in. A temperature (temperature information) detected by the temperature sensor 12a is sent to the ink supply control section 3. Further, the ink supply control section 3 controls the ink cooling section 7 and the ink heating section 9 so as to put the temperature of ink within a predetermined range, based on the temperature information.

Upon necessity, a temperature sensor 12b as a second temperature sensor for detecting an ink temperature of ejected ink may be provided at an ink ejection port of each of the short heads 2A, 2B, and 2C. If the temperature sensors 12a are provided near the ink supply ports of the short heads and if the temperature sensors 12b are provided near the ink ejection ports, temperatures T1 detected by the temperature sensors 12a and temperatures T2 detected by the temperature sensors 12b are sent to the ink supply control section 3. The ink supply control section 3 then calculates average values (intermediate values) between the temperatures T1 and T2, and controls the ink cooling section 7 and the ink heating section 9, based on the average values (intermediate values).

Alternatively, in a configuration in which only the temperature sensors 12a are provided at the ink supply ports, correction parameters are calculated in advance. Thereafter, the temperatures T1 detected by the temperature sensors 12a may be corrected and assumed to be ink temperatures inside heads. Still alternatively, if detected temperature differences are small, the temperatures T1 detected by the temperature sensors 12a may be used as the ink temperatures inside short heads.

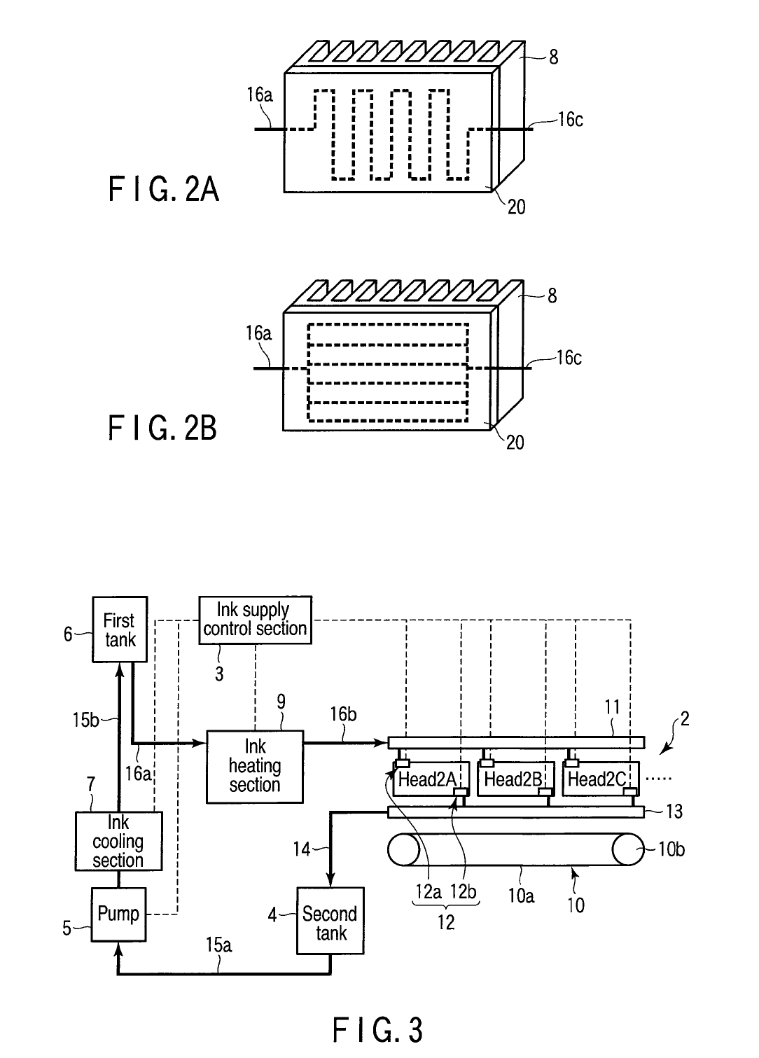

The ink cooling section 7 comprises a base member 20, a heat sink 8, and an unillustrated cooling fan, as illustrated in FIG. 2A and FIG. 2B. The base member 20 is a channel section where an ink flow path to flow ink supplied from the first ink tank 6 are formed. The heat sink 8 is a heat radiation member in tight contact with the base member 20. The unillustrated cooling fan is to cool the heat sink 8. The heat sink 8 and the cooling fan jointly constitute a heat radiation section.

The ink flow path formed in the base member 20 is configured in a meandering shape, for example, as illustrated in FIG. 2A, or in the form of parallel flow paths as illustrated in FIG. 2B. Such a flow path can extend a residence time of flowing ink so that an efficiency of heat exchange can be improved.

Further, the base member 20 is constituted by a member having a high heat conductivity, for example, made of copper or aluminum. The heat sink 8 is also constituted by a member having a high heat conductivity, for example, made of copper or aluminum. The heat sink 8 deprives heat of the base member 20. In other words, the heat sink 8 deprives heat of ink flowing through the base member 20 to thereby decrease the temperature of the ink. Thus, the heat sink 8 radiates heat of the ink flowing through the base member 20. The base member 20 and the heat sink 8 may be molded integrally or separately. Ink flow paths for other colors may be formed together in the base member 20 of the ink cooling section 7. All of the inks may then be simultaneously cooled by the single ink cooling section 7.

The cooling fan drives when a temperature of ink is higher than a predetermined temperature range suitable for image recording. This cooling fan sends air to the heat sink 8 to cool the heat sink 8. That is, the cooling fan improves heat radiation efficiency of the heat sink 8 by cooling the heat sink 8.

The ink heating section 9 comprises a base member (a channel section) and a heater.

The base member of the ink heating section 9 has a structure similar to the base member 20 of the ink cooling section 7 shown in FIGS. 2A and 2B. In other words, the base member of the ink heating section 9 comprises an ink flow path along which ink flows.

The heater is provided so as to surround the base member (channel section). As the heater, any resistor-type heater or any ceramic heater can be used provided temperature adjustment can be achieved by ordinary current control. The ink heating section 9 warms up ink flowing through the channel section by heating the channel section by the heater. Ink flow paths for other colors may be formed together in the base member (channel section) of the ink heating section 9, as well. All of the inks used may then be simultaneously heated by the single ink heating section 9.

Further, the ink cooling section 7 and ink heating section 9, which are characterizing features of the embodiment, are provided on the ink supply path 16 which connects the first ink tank 6 and the head section 2. The first ink tank 6 and the ink cooling section 7 are connected to each other by the ink supply path 16a. The ink supply path 16b connects the ink heating section 9 and the head section 2. The ink supply path 16c connects the ink cooling section 7 and the ink heating section 9. In other words, the ink cooling section 7 is provided in the upstream side on the ink supply path 16. In the downstream side thereof, the ink heating section 9 is provided to be close to an ink supply port of the head section 2. That is, in the upstream side relative to the ink heating section 9, the ink cooling section 7 is provided, and the head section 2 is provided in the downstream side. This configuration allows ink from the first ink tank 6 to flow to the ink cooling section 7, ink heating section 9, and head section 2 in this order.

A conveyor mechanism 10 comprises a conveyor belt 10a which conveys a recording medium so as to pass in front of each of the nozzles of the head section 2, and at least two rollers 10b which support the conveyor belt 10a to be rotatable. One of these rollers 10b is, for example, a drive roller connected to a drive source constituted by a motor, and the other one is a driven roller. Throughout whole surface of the conveyor belt 10a, a large number of holes having a small diameter are opened. By using a negative pressure which is generated by a fan provided separately, the recording medium is suctioned to the conveyor belt 10a and conveyed. Though not illustrated, there are provided a sheet feed mechanism which feeds one after another of recording media to the conveyor mechanism 10, and an ejection mechanism which ejects the recording media subjected to image recording.

A description will now be given of temperature adjustment for ink by the inkjet printer 1 configured as described above. The temperature adjustment for ink is executed in the state where ink is circulated.

There is importance in putting a temperature of ink within a temperature range which is predetermined depending on ink characteristics (referred to as a predetermined temperature range). However, heat generated by driving each of the ink heads in the head section 2 sometimes transfers to ink and increases thereby the temperature of ink beyond the predetermined temperature range. Inversely, a temperature of ink is sometimes lower than the predetermined temperature range due to an ambient temperature (environmental temperature) when staring up an apparatus.

Hence, the ink cooling section 7 and ink heating section 9 in the embodiment are controlled by the ink supply control section 3, based on temperatures of ink detected by the temperature sensors 12. That is, when a temperature of ink is higher than the predetermined temperature range, the ink supply control section 3 controls the ink cooling section 7 to cool the ink. When a temperature of ink is lower than the predetermined temperature range, the ink supply control section 3 controls the ink heating section 9 to heat the ink. When a temperature of ink is within the predetermined temperature range, the ink supply control section 3 neither heat nor cool the ink.

Specifically, when a temperature of ink is within the predetermined temperature range, the ink supply control section 3 drives neither the unillustrated cooling fan of the ink cooling section 7 nor the unillustrated heater of the ink heating section 9.

When a temperature of ink is higher than the predetermined temperature range, the ink supply control section 3 drives the unillustrated cooling fan of the ink cooling section 7 and does not drive the unillustrated heater of the ink heating section 9. In this state, heat of ink flowing through the channel section 20 in the ink cooling section 7 transfers to the heat sink 8. The heat sink 8 then radiates the heat transferred. That is, heat is deprived of ink having a high temperature when the ink passes through the ink cooling section 7, and the temperature decreases accordingly. The ink whose temperature has been decreased by the ink cooling section 7 passes through the ink heating section 9. However, the ink is not heated because the heater of the ink heating section 9 is not driven. Thus, the ink whose temperature has been decreased by the ink cooling section 7 flows into the head section 2 without being heated by the ink heating section 9.

When a temperature of ink is lower than the predetermined temperature range, the ink supply control section 3 does not drive the unillustrated cooling fan of the ink cooling section 7 but drives the unillustrated heater of the ink heating section 9. In this state, a temperature of ink flowing through the channel section in the ink heating section 9 increases because the channel section is heated by the heater. The ink heating section 9 is located closer to the head section 2 than the ink cooling section 7. In this location, the ink whose temperature has been increased by the ink heating section 9 does not pass through the ink cooling section 7 but directly flows into the head section 2. In other words, the heat sink 8 of the ink cooling section 7 does not deprives heat of the ink whose temperature has been increased by the ink heating section 9. If the ink cooling section 7 was located closer to the head section 2 than the ink heating section 9, the ink heating section 9 should intensely heat the ink so as to compensate for a temperature decrease which would be caused by the heat sink 8 of the ink cooling section 7. However, according to the embodiment, heated ink can be efficiently supplied to the head section 2 without requiring such compensative heating.

[First Modification]

Described next will be an inkjet printer according to the first modification to the first embodiment.

FIG. 3 illustrates a conceptual configuration of an inkjet printer which comprises an ink heating section and an ink cooling section according to the first modification. In FIG. 3, constitutive portions equivalent to those of the foregoing first embodiment illustrated in FIG. 1 will be denoted by the same reference symbols, and detailed descriptions thereof will be omitted herefrom.

This inkjet printer comprises at least: a first ink tank 6; a head section 2; an ink heating section 9; a second ink tank 4; a pump 5; an ink cooling section 7; an ink circulation path denoted by 14, 15, 16a, and 16b, which connects the foregoing members; an ink supply control section 3 which controls the pump 5, the ink cooling section 7 and the ink heating section 9; and a conveyor mechanism 10 for recording media.

In the present modification, the position of the ink cooling section 7 differs from the position where the ink cooling section 7 is located on the ink circulation path in the foregoing first embodiment. The ink heating section 9 is provided at the same position as in the first embodiment, and supplies heated ink directly to the head section 2.

The ink cooling section 7 is provided on the ink feedback path 15 through which ink is fed back from the second tank 4 to the first tank 6. Specifically, the ink cooling section 7 is provided in a downstream side of the pump 5 on an ink feedback path 15b between the pump 5 and the first tank. On the ink supply paths 16a and 16b, there is provided only the ink heating section 9. Differently from the layout in the first embodiment, a first tank 6 is configured to be inserted between the ink cooling section 7 and the ink heating section 9.

According to this configuration, the same operation and effects as in the first embodiment can be obtained.

[Second Modification]

Next, an inkjet printer according to the second modification to the first embodiment will be described.

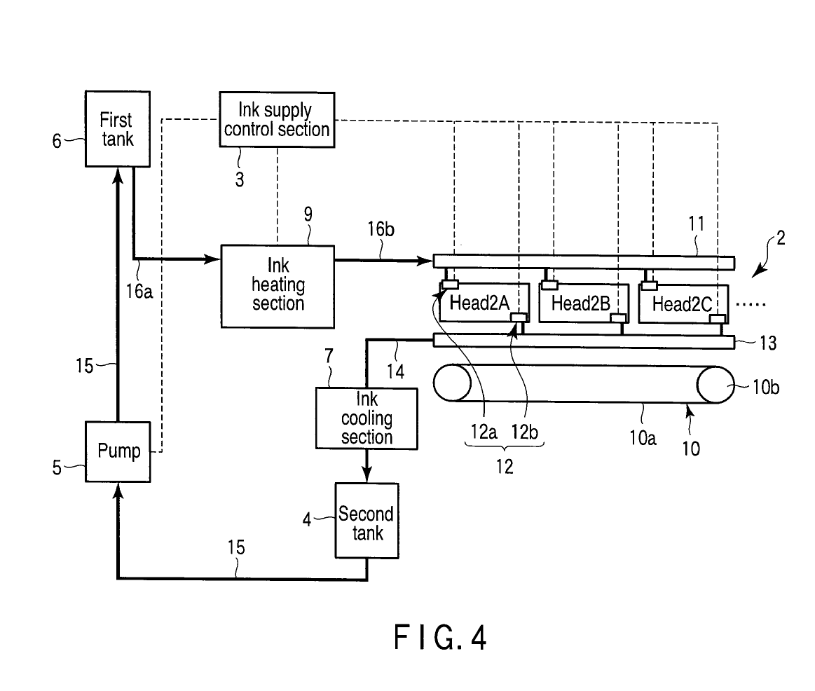

FIG. 4 illustrates a conceptual configuration of the inkjet printer according to the second modification, including an ink heating section and an ink cooling section. In FIG. 4, constitutive portions equivalent to those of the foregoing first embodiment illustrated in FIG. 1 will be denoted by the same reference symbols, and detailed descriptions thereof will be omitted herefrom.

This inkjet printer comprises at least: a first ink tank 6; a head section 2; an ink heating section 9; a second ink tank 4; an ink cooling section 7; a pump 5; an ink circulation path denoted by 14, 15, 16a, and 16b, which connects the foregoing members; an ink supply control section 3 which controls the pump 5, the ink cooling section 7 and the ink heating section 9; and a conveyor mechanism 10 for recording media.

In the present modification, the position of the ink cooling section 7 differs from the position where the ink cooling section 7 is located on the ink circulation path in the foregoing first embodiment. The ink heating section 9 is located at the same position as in the first embodiment, and supplies heated ink directly to the head section 2.

The ink cooling section 7 is provided on the ink collection path 14 through which ink is collected to the second tank 4 from the head section 2. Compared with a positional relationship between the ink cooling section 7 and the ink heating section 9 in the first embodiment, the second ink tank 4, pump 5, and first tank 6 are configured to be inserted between the ink cooling section 7 and the ink heating section 9.

According to this configuration, the same operation and effects as in the first embodiment can be obtained.

[Third Modification]

Next, an inkjet printer according to the third modification to the first embodiment will be described.

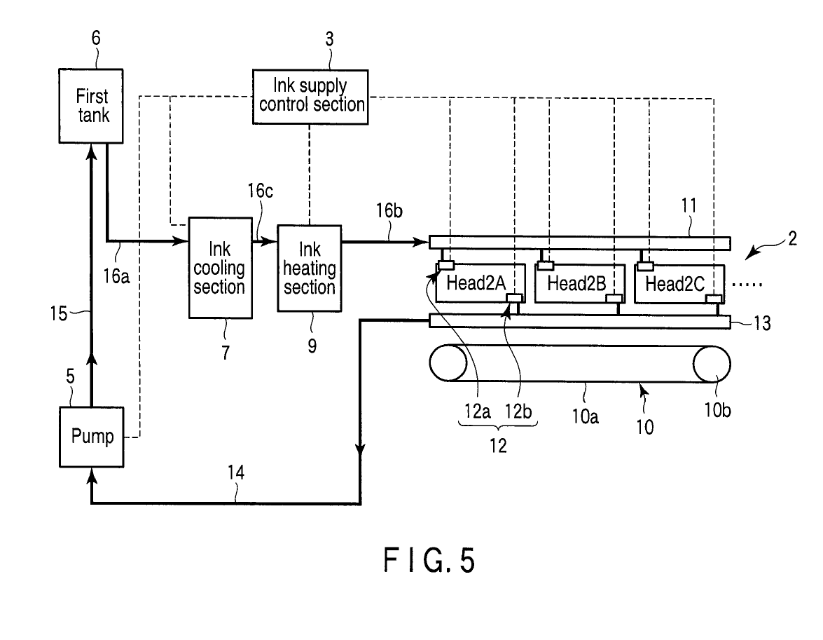

FIG. 5 illustrates a conceptual configuration of the inkjet printer according to the third modification, including an ink heating section and an ink cooling section. The present modification is configured by excluding a second ink tank from the configuration of the foregoing first embodiment. In FIG. 5, constitutive portions equivalent to those of the first embodiment will be denoted by the same reference symbols, and detailed descriptions thereof will be omitted herefrom.

This inkjet printer comprises at least: a first ink tank 6; a head section 2; an ink cooling section 7; an ink heating section 9; a pump 5; an ink circulation path denoted by 14, 15, 16a, 16b, and 16c which connects the foregoing members; an ink supply control section 3 which controls the pump 5, the ink cooling section 7 and the ink heating section 9; and a conveyor mechanism 10 for recording media.

An ink circulation path is constituted by ink supply paths 16a, 16b, and 16c which supply ink from the first ink tank 6 to the head section 2, a second path (an ink collection path 14 and an ink feedback path 15) which returns ink not discharged from the head section 2, back to the first tank 6.

In this configuration, ink from the first ink tank 6 is supplied to the head section 2, after passing through the ink cooling section 7 and the ink heating section 9 in this order. Further, the ink not discharged from the head section 2 returns to the first ink tank 6 by the pump 5.

According to this configuration, the same operation and effects as in the first embodiment can be obtained. Further, the foregoing first and second modifications have described configurations in which the position of the ink cooling section 7 is changed to above the ink feedback path 15 or above the ink collection path 14. Also in this third modification, the ink cooling section 7 can be easily moved to any position. The same operation and effects as in the first and second modifications can be obtained.

### Second Embodiment

Next, an image recording device according to the second embodiment will be described.

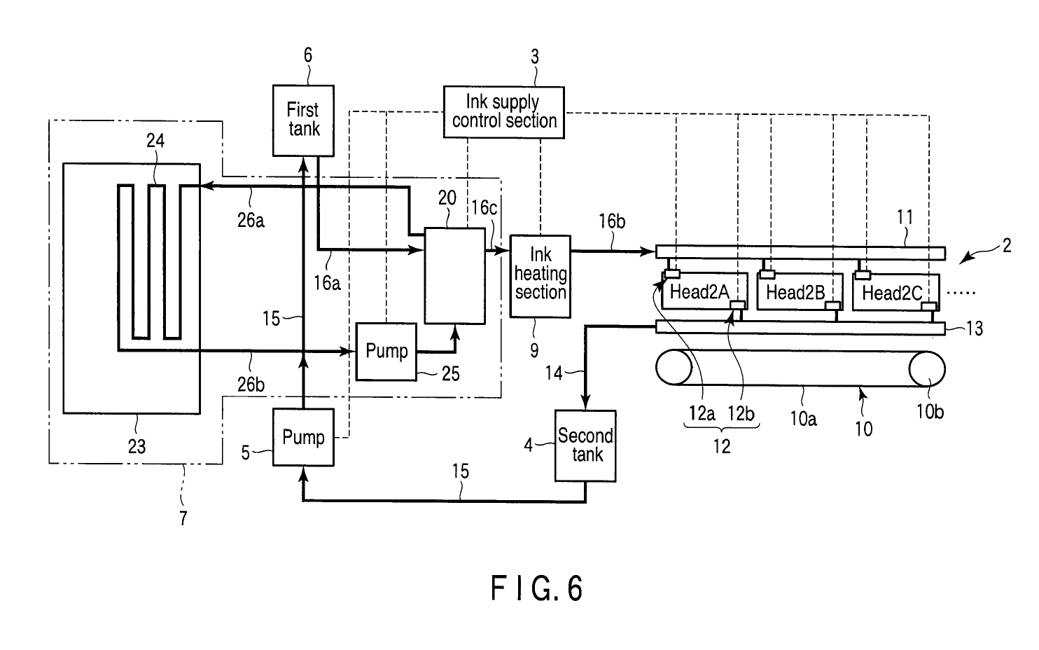

FIG. 6 illustrates a conceptual configuration of an inkjet printer which comprises an ink heating section and an ink cooling section, according to the second embodiment. The embodiment differs from the foregoing first embodiment only in the configuration of a heat radiation section of an ink cooling section 7. In FIG. 6, constitutive portions equivalent to those of the first embodiment will be denoted by the same reference symbols, and detailed descriptions thereof will be omitted herefrom.

This inkjet printer 1 comprises at least: a first ink tank 6; a head section 2; an ink cooling section 7; an ink heating section 9; a second ink tank 4; a pump 5; an ink circulation path denoted by 14, 15, 16a, 16b, and 16c, which connects the foregoing members; an ink supply control section 3 which controls the pump 5, the ink cooling section 7 and the ink heating section 9; and a conveyor mechanism 10 for recording media. Also in the embodiment, the ink heating section 9 is provided near an ink supply port of the head section 2, and directly supplies heated ink.

The embodiment is configured such that the heat radiation section of the ink cooling section 7 is located apart.

The heat radiation section is constituted by an apparatus frame 23, a heat radiation member 24 as a channel to flow a coolant, coolant paths 26a and 26b, and a pump 25. The apparatus frame 23 is constituted by a metal and functions as a heat radiation plate.

The heat radiation member 24 is integrally fixed to the apparatus frame 23 and is formed like pipes from a material having a high heat conductivity. To raise a heat radiation efficiency, the heat radiation member 24 is curved in a meandering shape. For the heat radiation member 24, a fixing method such as brazing is suitable in order to make tight contact with the apparatus frame 23 and to improve heat conductance.

This heat radiation member 24 is connected to the base member 20 through the coolant paths 26a and 26b. Specifically, in the embodiment, a cooling channel capable of flowing a coolant is provided in the base member 20 of the ink cooling section 7, in addition to an ink flow path. An inlet port of the heat radiation member 24 and an ejection port of the cooling channel in the base member 20 are connected by a coolant path 26a. An ejection port of the heat radiation member 24 and an inlet port of the cooling channel in the base member 20 are connected by a coolant path 26b.

Further, the pump 25 is inserted on the coolant path 26b, and a coolant is configured to circulate between the base member 20 and the heat radiation section in accordance with liquid feed by the pump. A cooling operation based on this coolant is controlled by the ink supply control section 3, in association with ink supply controls for other constitutive portions.

Ink which has passed through the base member 20 is deprived of heat and thereby cooled. Further, the coolant which has received heat from the ink and has accordingly increased in temperature passes through the coolant path 26a and flows into the radiation member 24, fed by the pump 25. From the ink, heat is efficiently radiated to the air passing through the apparatus frame 23 when the ink passes through the heat radiation member 24. The temperature of the coolant is thereby decreased. The coolant whose temperature has decreased is fed by the pump 25 and returns to the base member 20.

Further, when ink is heated by the ink heating section 9, the pump 25 stops and does not circulate the coolant.

As has been described above, according to the embodiment, the same operation and functions as in the first embodiment can be obtained, and the heat radiation section of the ink cooling section 7 is a heat sink which is not directly attached to the base member 20 but is located apart from the base member 20. In this manner, an increase in temperature of the heat sink is not caused by heat which is generated from the ink heating section 9 and is carried outside. Further, the coolant is cooled by the apparatus frame 23. Therefore, a cooling efficiency for ink can be improved.

### Third Embodiment

Next, an inkjet printer according to the third embodiment will be described.

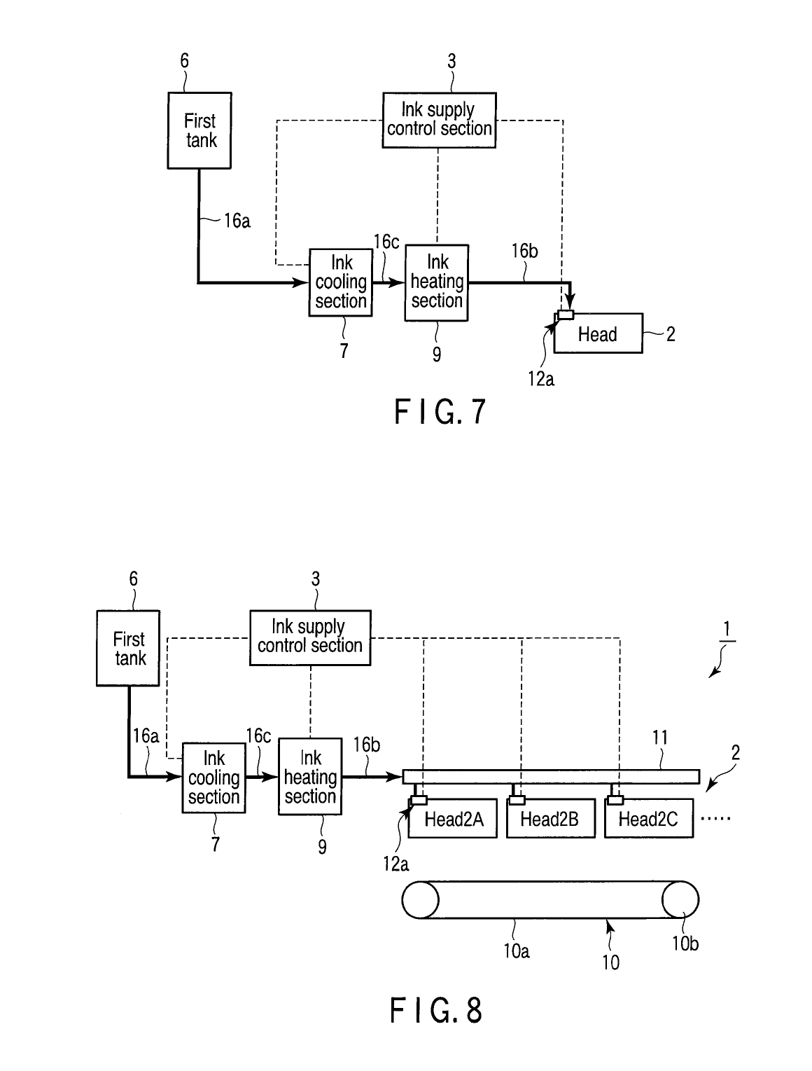

FIG. 7 illustrates a conceptual configuration of an inkjet printer which comprises an ink heating section and an ink cooling section, according to the third embodiment. The foregoing first and second embodiments each have proposed an ink heating section and an ink cooling section built in an inkjet printer which circulates ink. In contrast, the embodiment will now describe an ink heating section and an ink cooling section built in an inkjet printer which does not circulate ink, i.e., which comprises only ink supply paths but does not comprise an ink collection path and an ink feedback path. The ink collection path described herein is not an ink collection path (waste ink path) for ink ejected by overflow or cleaning processing.

In FIG. 7, constitutive portions equivalent to those of the first embodiment will be denoted by the same reference symbols, and detailed descriptions thereof will be omitted herefrom. The inkjet printer according to the embodiment comprises a fixed line recording head which records an image on a conveyed recording medium, as described above, and a scan recording head (a so-called serial recording head) which records an image while moving relative to a conveyed recording medium. As illustrated in FIG. 7, the embodiment comprises: a first ink tank 6; a head section 2; an ink cooling section 7; an ink heating section 9; an ink supply path denoted by 16a, 16b, and 16c; an ink supply control section 3 which controls the ink cooling section 7 and the ink heating section 9; and a conveyor mechanism 10 for recording media.

Also in the embodiment, the ink heating section 9 is provided near an ink supply port of the head section 2, and directly supplies heated ink. That is, relative to the ink heating section 9, the ink cooling section 7 is provided in an upstream side, and the head section 2 is provided in a downstream side so as to be connected through no constitutive member inserted therebetween. A temperature sensor 12a which detects a temperature of ink is provided at an ink supply port of the head section 2. Temperature information detected by the temperature sensor 12a is sent to the ink supply control section 3. Temperature adjustment of ink is performed based on cooling or heating by the ink cooling section 7 and the ink heating section 9.

In this configuration, ink flows from the first ink tank 6 through the ink supply path 16a into the ink cooling section 7, and further flows from the ink cooling section 7 through the ink supply path 16c to the ink heating section 9. The ink is then supplied from the ink heating section 9 through the ink path 16b to the head section 2. Thus, the ink from the first ink tank 6 flows through the ink cooling section 7, ink heating section 9, and head section 2 in this order.

A large number of unillustrated nozzles (piezoelectric elements) and a head drive circuit (circuit board) are provided in the head section 2. The head drive circuit inputs a drive waveform to selected piezoelectric elements and causes the elements to discharge ink.

The ink cooling section 7 comprises a base member 20, a heat sink 8, and an unillustrated cooling fan, as illustrated in FIG. 2A and FIG. 2B. The base member 20 is a channel section where an ink flow path to flow ink is formed. The heat sink 8 is a heat radiation member in tight contact with the base member 20. The unillustrated cooling fan is to cool the heat sink 8. The ink flow path formed in the base member 20 is configured in a meandering shape, for example, as illustrated in FIG. 2A, or in the form of parallel flow paths as illustrated in FIG. 2B. Such a flow path can extend a residence time of flowing ink so that an efficiency of heat exchange can be improved.

Further, the base member 20 is constituted by a member having a high heat conductivity, for example, made of copper or aluminum. The heat sink 8 is also constituted by a member having a high heat conductivity, for example, made of copper or aluminum. The heat sink 8 deprives heat of the base member 20. In other words, the heat sink 8 deprives heat of ink flowing through the base member 20 to thereby decrease the temperature of the ink. Thus, the heat sink 8 radiates heat of the ink flowing through the base member 20.

The base member 20 and heat sink 8 may be molded integrally or separately.

The ink heating section 9 comprises a base member (a channel section) and a heater. The base member of the ink heating section 9 has a structure similar to the base member 20 of the ink cooling section 7 shown in FIGS. 2A and 2B. In other words, the base member of the ink heating section 9 comprises an ink flow path along which ink flows.

A heater is provided so as to surround this base member 20. As the heater, any resistance heater or any ceramic heater can be used provided temperature adjustment can be achieved by an ordinary current control.

Further, the conveyor mechanism 10 comprises a conveyor belt and at least two rollers. The conveyor belt conveys a recording medium so that it passes in front of the head section 2. The two rollers are a drive roller and a slave roller which support the conveyor belt to be rotatable.

Throughout the whole surface of the conveyor belt, a large number of holes having a small diameter are opened. By a negative pressure generated by a fan, a recording medium is suctioned to the conveyor belt and conveyed. Further, though not illustrated, there are provided a sheet supply mechanism which feeds one after another of recording media to the conveyor mechanism 10, and an ejection mechanism which ejects the recording media subjected to image recording.

Thus, in the embodiment, the ink heating section 9 is provided in a side closer to the head section 2 than the ink cooling section 7. Owing to this layout, ink which has been heated by the heater of the ink heating section 9 to have an increased temperature is caused to flow directly into the head section 2, without passing through the ink cooling section 7 having cooling fins (heat sink) and a large heat capacity.

Accordingly, a temperature drop is small until ink reaches the head section 2, and ink can be efficiently heated.

[Modification]

FIG. 8 illustrates a conceptual configuration of the inkjet printer according to a modification to the third embodiment, including an ink heating section and an ink cooling section. In FIG. 8, constitutive portions equivalent to those of the third embodiment will be denoted by the same reference symbols, and detailed descriptions thereof will be omitted herefrom.

The head section 2 according to the embodiment is configured by arraying plural short heads 2A, 2B, and 2C widthwise in a recording medium. A fixed line recording head is divided into the plural short heads which respectively form images such that ends of the images overlap one another.

The same operation and effects as in the third embodiment can also be obtained with the present modification.

Each of the first and second embodiments described above deals with an example in which ink is heated by providing an ink heating section on an ink supply path. If an ink tank is small and an amount of stored ink is small as in a serial recording head, the ink tank itself may be heated insofar as ink flows through an ink cooling section, an ink heating section, and a head section in this order.

As has been described above, in the embodiments and modifications thereof according to the present invention, heated ink can be efficiently supplied to a head section after heating because any unit which may deprive the ink of heat is not provided in a downstream side.

Therefore, the present invention can form high-quality images on recording media by heating or cooling ink in accordance with ink temperature.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An inkjet printer comprising:
a head section including an ink head which discharges ink;
an ink heating section including a heater which heats the ink supplied to the head section; and
an ink cooling section including a heat sink which cools the ink supplied to the head section, wherein
the ink which has passed through the ink cooling section and the ink heating section in this order flows into the head section.

2. The inkjet printer of claim 1, further comprising:
a temperature sensor which detects a temperature of the ink; and
a cooling fan which sends air toward the heat sink, wherein
the heater is stopped and the cooling fan is driven if the temperature of the ink is detected to be higher than a predetermined temperature range by the temperature sensor, and
the heater is driven and the cooling fan is stopped if the temperature of the ink is detected to be lower than the predetermined temperature range by the temperature sensor.

3. An inkjet printer comprising:
an ink tank which stores ink;
a head section including an ink head which discharges the ink supplied from the ink tank through a first path;
a pump which returns the ink not discharged from the head section, back to the ink tank through a second path;
an ink heating section including a channel section through which the ink flows, and a heater which heats the channel section;
an ink cooling section including a channel section through which the ink flows, and a heat sink which radiates heat of the ink flowing through the channel section;
a temperature sensor which detects a temperature of the ink; and
a control section which drives the heater if the temperature of the ink is detected to be lower than a predetermined temperature range by the temperature sensor, wherein
the ink heating section is provided on the first path, and the ink cooling section is provided on the first path between the ink tank and the ink cooling section or on the second path.

4. The inkjet printer of claim 3, wherein
the ink cooling section further comprises a cooling fan which sends air toward the heat sink, and
the control section stops the heater and drives the cooling fan if the temperature of the ink is detected to be higher than the predetermined temperature range by the temperature sensor, and the control section drives the heater and stops the cooling fan if the temperature of the ink is detected to be lower than the predetermined temperature range by the temperature sensor.

5. The inkjet printer of claim 4, wherein
the temperature sensor comprises a first temperature sensor which detects a temperature of the ink flowing into the head section, and a second temperature sensor which detects a temperature of the ink flowing out of the head section, and
the control section controls the heater and the cooling fan, based on detection results from the first and second temperature sensors.

6. The inkjet printer of claim 5, wherein
the control section calculates an intermediate value between the temperatures detected by the first and second temperature sensors, and controls the heater and the cooling fan, based on the intermediate value.

7. The inkjet printer of claim 3, wherein
the ink cooling section further comprises a cooling fan which sends air toward the heat sink,
the temperature sensor comprises a first temperature sensor which detects a temperature of the ink flowing into the head section, and a second temperature sensor which detects a temperature of the ink flowing out of the head section, and
the control section controls the heater and the cooling fan, based on detection results from the first and second temperature sensors.

8. The inkjet printer of claim 3, wherein
the inkjet printer further comprises a collection tank which collects the ink not discharged from the head section,
the second path is constituted by an ink collection path which connects the head section and the collection tank, and an ink feedback path which connects the collection tank and the ink tank,
the pump is provided on the ink feedback path, and
the ink cooling section is provided on the first path between the ink tank and the ink heating section, or is provided on the ink collection path or on the ink feedback path.

9. The inkjet printer of claim 8, wherein
the ink tank is located higher than the head section in a direction of gravitation, and the collection tank is located lower than the head section in the direction of gravitation.

10. The inkjet printer of claim 3, wherein
the channel section of the ink cooling section is made of aluminum.

11. The inkjet printer of claim 3, wherein
the channel section of the ink heating section is made of aluminum.

12. An inkjet printer comprising:
a first tank which stores ink;
a head section including an ink head which discharges the ink supplied from the first tank through an ink supply path;
a second tank which collects, through an ink collection path, the ink not discharged from the head section;
a pump which returns the ink collected by the second tank, back to the first tank through an ink feed back path;
an ink heating section including a heater which heats the ink;
an ink cooling section which cools the ink by radiating heat of the ink through a heat sink;
a temperature sensor which detects a temperature of the ink; and
a control section which drives the heater if the temperature of the ink is detected to be lower than a predetermined temperature range by the temperature sensor, wherein
the ink heating section is provided on the ink supply path, and the ink cooling section is provided on the ink supply path between the first tank and the ink heating section or is provided on the ink collection path or on the ink feedback path.

13. The inkjet printer of claim 12, wherein
the ink cooling section further comprises a cooling fan which sends air toward the heat sink, and
the control section stops the heater and drives the cooling fan if the temperature of the ink is detected to be higher than the predetermined temperature range by the temperature sensor, and the control section drives the heater and stops the cooling fan if the temperature of the ink is detected to be lower than the predetermined temperature range by the temperature sensor.

14. The inkjet printer of claim 13, wherein
the temperature sensor comprises a first temperature sensor which detects a temperature of the ink flowing into the head section, and a second temperature sensor which detects a temperature of the ink flowing out of the head section, and
the control section controls the heater and the cooling fan, based on detection results from the first and second temperature sensors.

15. The inkjet printer of claim 14, wherein
the control section calculates an intermediate value between the temperatures detected by the first and second temperature sensors, and controls the heater and the cooling fan, based on the intermediate value.

16. The inkjet printer of claim 12, wherein
the ink cooling section further comprises a cooling fan which sends air toward the heat sink,
the temperature sensor comprises a first temperature sensor which detects a temperature of the ink flowing into the head section, and a second temperature sensor which detects a temperature of the ink flowing out of the head section, and
the control section controls the heater and the cooling fan, based on detection results from the first and second temperature sensors.

17. The inkjet printer of claim 12, wherein
the first tank is located higher than the head section in a direction of gravitation, and the second tank is located lower than the head section in the direction of gravitation.
